(19) United States
(12) Patent Application Publication
(10) Pub. No.: US 2011/0087921 A1
(43) Pub. Date: Apr. 14, 2011

(54) REPRODUCING APPARATUS, INTEGRATED CIRCUIT, AND REPRODUCING METHOD

(75) Inventors: Kenichi TACHIBANA, Kanagawa (JP); Hisashi Fukugawa, Kanagawa (JP); Hiroko Mori, Kanagawa (JP); Michimasa Okubo, Tokyo (JP); Shinya Taira, Kanagawa (JP)

(73) Assignee: PANASONIC CORPORATION, Osaka (JP)

(21) Appl. No.: 12/961,141

(22) Filed: Dec. 6, 2010

Related U.S. Application Data
(63) Continuation of application No. PCT/JP2009/001978, filed on Apr. 30, 2009.

(30) Foreign Application Priority Data
Jun. 6, 2008 (JP) 2008-149419

(51) Int. Cl. G06F 11/14

(52) U.S. Cl. 714/23; 714/E11.137

(57) ABSTRACT

A reproducing apparatus 100 that reproduces content recorded in a recording medium 101 avoids reentering the same fault state and becoming unrecoverable at the time of occurrence of an unrecoverable CPU error, such as misalignment. Fault information is stored in nonvolatile memory, or the like, and the thus-stored fault information is used to cause reproduction control processing to branch before execution of a processing routine to be invoked at the time of occurrence of an unrecoverable CPU error, such as misalignment, thereby preventing the reproducing apparatus from reentering the same fault state.

### BACKGROUND OF THE INVENTION

1. Technical Field

The present invention relates to a reproducing apparatus, an integrated circuit, and a reproducing method for reproducing video data, music data, and the like, recorded on a storage medium, like an optical disk, and, more particularly, to a reproducing apparatus, an integrated circuit, and a reproducing method that enable avoiding repeat of an unrecoverable fault when the unrecoverable fault has occurred.

2. Background Art

An increasing demand recently exists for quality of a vehicle mounted system and software. With an increase in the number of self-created contents circulated, such as video data and music data, it becomes increasingly important for a reproducing apparatus that reproduces video data, music data, and the like, to enhance resistance to violation of content standards.

A CPU error, such as a misalignment, often occurs in the reproducing apparatus for reasons of violation of content standards, and the like. When the CPU error has occurred, operation of the reproducing apparatus depends on hardware. In general, an interrupt occurs, a routine for executing interrupt processing runs. In order to let a system recover from the routine that executes interrupt processing to normal processing, the system must be rebooted by triggering; for instance, a reset.

A hitherto proposed method for preventing occurrence of a CPU error due to software requires a configuration for letting hardware able to recover from an interrupt or a configuration for preventing automatic execution of interrupt processing. Related art methods for preventing occurrence of a CPU error due to software are subject to hardware restrictions (see; for instance, Patent Documents 2 and 3). Therefore, it is difficult to prevent occurrence of a CPU error, such as a misalignment, by means of only software-oriented countermeasures.

Moreover, pieces of other related art reproducing apparatus store fault information in nonvolatile memory and utilize the saved fault information for analysis of the faults, or the like, (see; for instance, Patent Document 1).
Patent Document 1: JP-A-2004-14015
Patent Document 2: JP-A-2005-234752
Patent Document 3: JP-A-8-16420

When the reproducing apparatus has entered an unrecoverable state as a result of occurrence of a CPU error, such as misalignment and an unauthorized memory access, the system sometimes becomes unrecoverable even when rebooted. For example, in a case where a CPU error has occurred during disc identification processing, identification processing will be again performed regardless of user operation if the system reboot is performed. This may bring the system into an unrecoverable state.

Conceivable countermeasures to prevent the system from entering an unrecoverable state, which would otherwise be caused by occurrence of a CPU error, such as misalignment and an unauthorized memory access are hardware-oriented countermeasures; however, the countermeasures may lead to an increase in device development cost.

### SUMMARY OF THE INVENTION

Accordingly, an objective of the present invention is to provide a reproducing apparatus, an integrated circuit, and a reproducing method that make it possible to prevent a system from entering an unrecoverable state and enhance system resistance to an unrecoverable fault by means of only software-oriented countermeasures without being subject to hardware restrictions.

The present invention provides a reproducing apparatus comprising: a first execution unit that configured to perform a control processing for reproducing content recorded in a recording medium; a second execution unit configured to execute a processing routine which is invoked when the reproducing apparatus has become unrecoverable or temporarily uncontrollable during the control processing; a storage unit configured to store fault information showing that the reproducing apparatus is in an unrecoverable state or temporarily uncontrollable; and a branch unit configured to cause alternative processing, which is for preventing the reproducing apparatus from again entering an unrecoverable state or temporarily becoming uncontrollable after the reproducing apparatus has once become unrecoverable or temporarily uncontrollable during the control processing, to branch off from the control processing, which is for reproducing the content recorded in the recording medium, by using the fault information recorded in the storage unit and that executes the branched alternative processing.

Even when the reproducing apparatus has become unrecoverable from an uncontrollable state during control processing for reproducing content recorded in a recording medium, the reproducing apparatus causes control processing to branch by use of fault information stored in the reproducing apparatus, thereby making it possible to avoid reentering the same uncontrollable state.

In the reproducing apparatus, the processing routine includes processing for rebooting the reproducing apparatus by resetting software after the fault information has been saved in the storage unit.

The reproducing apparatus imposes limitations on a file analysis request, or the like, to the reproducing apparatus, thereby making it possible to prevent repeat of the unrecoverable fault.

In the reproducing apparatus, the fault information is one that makes it possible to specify a state in which the reproducing apparatus has become unrecoverable or temporarily uncontrollable and that includes a state of the reproducing apparatus and information about the recording medium.

In the reproducing apparatus, the branch unit causes control processing to branch according to the state of the reproducing apparatus and the information about the recording medium.

In the reproducing apparatus, the fault information shows a misalignment error.

In the reproducing apparatus, the fault information shows an unauthorized memory access error.

In the reproducing apparatus, the fault information shows a timeout error of a watchdog timer.

The present invention provides an integrated circuit comprising: a first execution unit that configured to perform control processing of a reproducing apparatus that reproduces content recorded in a recording medium; a second execution unit configured to execute a processing routine that is invoked when the reproducing apparatus has become unrecoverable or temporarily uncontrollable during the control processing; a storage unit configured to store fault information showing that the reproducing apparatus is in an unrecoverable state or temporarily uncontrollable; and a branch unit configured to cause alternative processing, which is for preventing the reproducing apparatus from again entering an unrecoverable state or temporarily becoming uncontrollable after the reproducing apparatus has once become unrecoverable or temporarily uncontrollable during the control processing, to branch off from control processing, by using the fault information stored in the storage unit and that executes the branched alternative processing.

Even when the reproducing apparatus has become unrecoverable from an uncontrollable state during control processing, the integrated circuit causes control processing to branch by use of fault information stored in the integrated circuit, thereby making it possible to avoid reentering the same uncontrollable state.

In the integrated circuit, the processing routine includes processing for rebooting the reproducing apparatus by resetting software after the fault information has been saved in the storage unit.

In the integrated circuit, limitations are imposed on a file analysis request, or the like, to the reproducing apparatus, thereby making it possible to prevent repeat of the unrecoverable fault.

In the integrated circuit, the fault information is one that makes it possible to specify a state in which the reproducing apparatus has become unrecoverable or temporarily uncontrollable and that includes a state of the reproducing apparatus and information about the recording medium.

In the integrated circuit, the branch unit causes control processing to branch according to the state of the reproducing apparatus and the information about the recording medium.

In the integrated circuit, the fault information shows a misalignment error.

In the integrated circuit, the fault information shows an unauthorized memory access error.

In the integrated circuit, the fault information shows a timeout error of a watchdog timer.

The present invention provides a reproducing method comprising: a first execution step of performing control processing of a reproducing apparatus that reproduces content recorded in a recording medium; a second execution step of executing a processing routine which is invoked when the reproducing apparatus has become unrecoverable or temporarily uncontrollable during control processing; a step of storing fault information showing that the reproducing apparatus is in an unrecoverable state or temporarily uncontrollable; and a step of causing alternative processing, which is for preventing the reproducing apparatus from again entering an unrecoverable state or temporarily becoming uncontrollable after the reproducing apparatus has once become unrecoverable or temporarily uncontrollable during the control processing, to branch off from the control processing, which is for reproducing the content recorded in the recording medium, by using the fault information and executing the branched alternative processing.

According to the reproducing method, even when the reproducing apparatus has become unrecoverable from an uncontrollable state during control processing, control processing is caused to branch by use of stored fault information, thereby making it possible to avoid reentering the same uncontrollable state.

Under the reproducing method, the processing routine includes processing for rebooting the reproducing apparatus by resetting software after the fault information has been saved in a storage unit.

According to the reproducing method, limitations are imposed on a file analysis request, or the like, to the reproducing apparatus, thereby making it possible to prevent repeat of the unrecoverable fault.

Under the reproducing method, the fault information is one that makes it possible to specify a state in which the reproducing apparatus has become unrecoverable or temporarily uncontrollable and that includes a state of the reproducing apparatus and information about the recording medium.

Under the reproducing method, the branch unit causes control processing to branch according to the state of the reproducing apparatus and the information about the recording medium.

Under the reproducing method, the fault information shows a misalignment error.

Under the reproducing method, the fault information shows an unauthorized memory access error.

Under the reproducing method, the fault information shows a timeout error of a watchdog timer.

According to the reproducing apparatus, the integrated circuit, and the reproducing method of the present invention, it is possible to yield an advantage of the ability to avoid reentering a similar uncontrollable state by causing control processing to branch by use of fault information stored in the apparatus even when the apparatus has become unrecoverable from an uncontrollable state during control processing.

### BRIEF DESCRIPTION OF THE DRAWINGS

FIG. 1 is a drawing showing a general configuration of a reproducing apparatus of an embodiment of the present invention.

FIG. 2 is a schematic diagram showing a physical configuration of a control unit of the reproducing apparatus of the embodiment of the present invention.

FIG. 3 is a flowchart for describing processing performed at the time of occurrence of a fault in the present embodiment of the present invention.

FIG. 4 is a flowchart for describing processing performed after rebooting of the reproducing apparatus subsequent to occurrence of the fault in the present embodiment of the present invention.

FIG. 5 is a view for describing fault information in the present embodiment of the present invention.

FIG. 6 is a flowchart for describing file analysis processing in the present embodiment of the present invention.

### DESCRIPTION OF THE PREFERRED EMBODIMENTS

An embodiment for implementing the present invention is hereunder described by reference to the drawings.

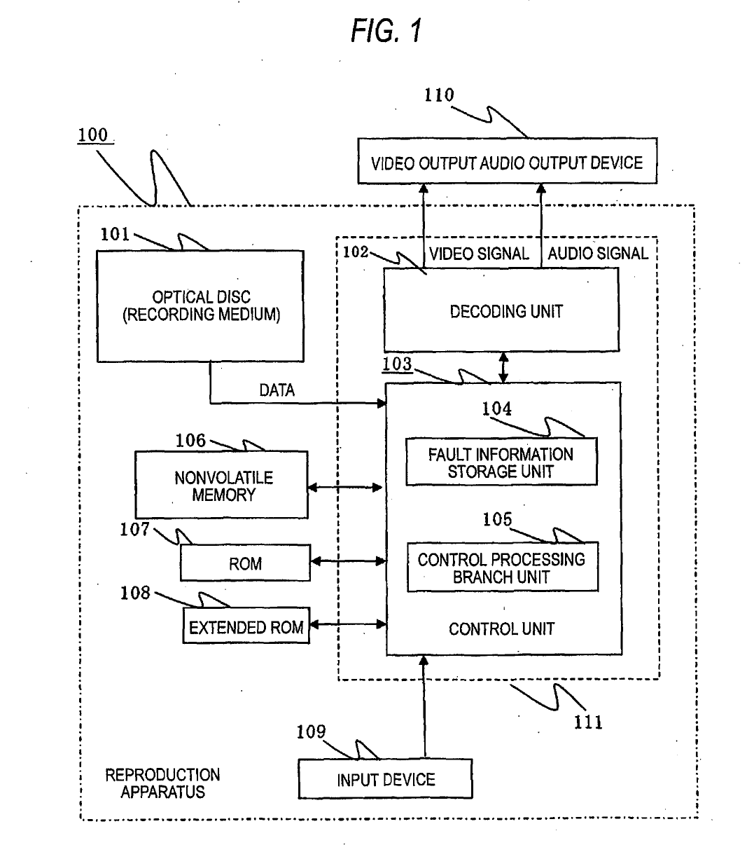

FIG. 1 is a drawing showing a general configuration of a reproducing apparatus of the embodiment of the present invention.

A reproducing apparatus 100 includes a recording medium 101, a decoding unit 102, a control unit 103, nonvolatile memory 106, ROM 107, extended RAM 108, and an input device 109. In the embodiment, an optical disc, such as a DVD, is used as a recording medium.

The recording medium 101 records file system data, compressed video data, audio data, and so on.

The decoding unit 102 decodes input data into video data and audio data under control of the control unit 103 to be described later and outputs a video signal and an audio signal to a video audio output device 110 to be described later.

The control unit 103 controls analysis of file system data fetched from the recording medium 101, reproduction control responsive to a request from the input device 109, and control of the entire reproducing apparatus 100. Moreover, the control unit 103 includes a fault information storage unit 104 storing fault information and a control processing branch unit 105 that branches control processing by use of the fault information.

The input device 109 includes a plurality of keys and a remote controller used by a user to send a control command to the control unit 103. The input device 109 is often connected to; for instance, a navigation unit and a control microcomputer, as well as to the keys and the remote controller.

The video audio output device 110 is built from; for instance, a display. The video audio output device 110 converts a video signal acquired from the decoding unit 102 so that the video signal can be displayed on a display. Likewise, the video audio output device 110 converts an audio signal acquired from the decoding unit 102 so that the audio signal can be output as sound.

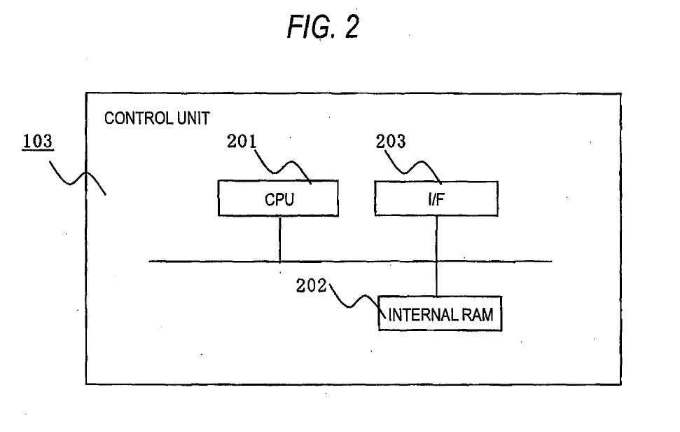

FIG. 2 is a schematic diagram showing a physical configuration of the control unit 103 of the reproducing apparatus 100 of the embodiment. The control unit 103 includes a CPU 201, internal RAM 202, and an I/F 203. The I/F 203 sends and receives data to and from the optical disc 101, the decoding unit 102, the input device 109, the nonvolatile memory 106, the ROM 107, the extended RAM 108, and so on.

A function of the fault information storage unit 104 and a function of the control processing branch unit 105 are implemented by means of the CPU 201 built in the control unit 103 by reading a program code stored in the ROM 107. The reproducing apparatus 100 of the present embodiment houses therein the ROM 107 that records a program code of software for implementing the function of the fault information storage unit 104 and the function of the control processing branch unit 105, which will be described later. A CPU of the reproducing apparatus reads a program code recorded in the ROM 107, thereby implementing a function of the fault information storage unit 104 and a function of the control processing branch unit 105.

When a portion or entirety of the program code is rewritten; for instance, in order to expand functions or make corrections to the function, an upgrade disc in which there are recorded a program code for implementing the function of the fault information storage unit 104 and the function of the control processing branch unit 105 is often used in place of the recording medium 101. The program code read from the upgrade disc is stored in the ROM 107. The CPU 201 accommodated in the control unit 103 reads the program code stored in the ROM 107 and implements the function of the fault information storage unit 104 and the function of the control processing branch unit 105.

The extended RAM 108 is used when the decoding unit 102 and the control unit 103 store a large amount of data in excess of storage capacity of the internal RAM 202.

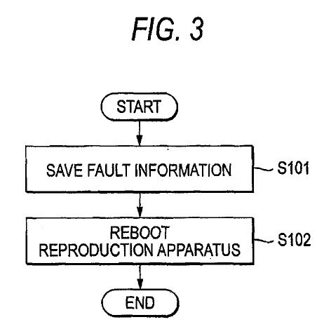

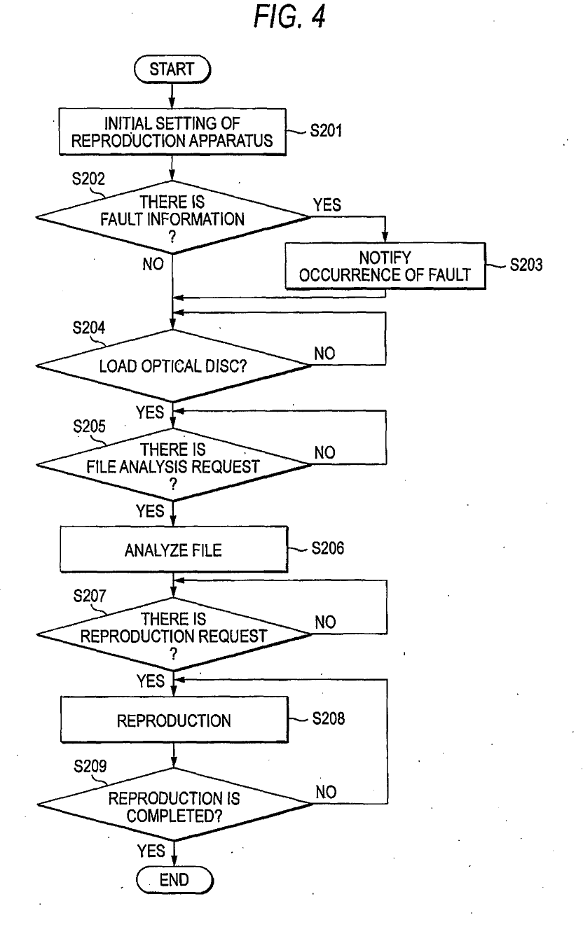

By reference to FIGS. 3 and 4, an explanation is given to control operation of the reproducing apparatus 100 performed when unrecoverable fault has occurred. FIG. 3 is a flowchart for describing processing performed at the time of occurrence of a fault in the reproducing apparatus 100. FIG. 4 is a flowchart for describing processing performed after rebooting of the reproducing apparatus 100 subsequent to occurrence of the fault in the reproducing apparatus 100.

First, an explanation is given to a processing flow employed when the fault information storage unit 104 and the control processing branch unit 105 inhibit repeat of the fault.

When unrecoverable fault is caused by a CPU error, like a misalignment error and unauthorized memory access, a CPU of the reproducing apparatus first saves occurrence of the unrecoverable fault in the fault information storage unit 104 (step S101), as shown in FIG. 3. The CPU resets the software, thereby rebooting the reproducing apparatus 100 (step S102). As a result of resetting of the software, there is a case where a power supply to the reproducing apparatus 100 is temporarily interrupted. Therefore, the fault information storage unit 104 saves fault information in the nonvolatile memory 106. Processing shown in FIG. 3 corresponds to a processing routine called in the present invention.

In addition to the case of occurrence of an unrecoverable fault, processing for occurrence of a fault shown in FIG. 3 may also be performed when the reproducing apparatus 100 has become uncontrollable for a given period, as in a case where a watchdog timer has caused a timeout.

Processing subsequent to occurrence of a fault in the reproducing apparatus 100 and processing subsequent to rebooting of the reproducing apparatus 100 are now described by reference to FIG. 4. Processing shown in FIG. 4 corresponds to a portion of processing control referred to herein.

First, the CPU performs initial setting of the reproducing apparatus 100 (step S201), thereby reading fault information from the nonvolatile memory 106 (step S202). When the fault information is saved, the CPU notifies the input device 109 of the fault information (step S203). The input device 109 received the notification about the fault information imposes a limitation on a file analysis request, or the like, to the reproducing apparatus 100, thereby preventing repeat of the unrecoverable fault. When the fault information is not saved, the CPU checks whether or not the recording medium 101 is loaded (step S204) and further awaits a file analysis request from the input device 109 (step S205).

When the file analysis request is received from the input device 109, the CPU performs file analysis processing (step S206). The CPU reads file system information from the storage medium 101 and analyzes a file system, thereby identifying reproducible content among contents stored in the storage medium 101. After identification of the reproducible content, a reproduction request from the input device is awaited (step S207).

When the reproduction request is received from the input device 109, the CPU performs reproduction processing (step S208). The video data and the audio data, which have been read from the storage medium 101 and compressed, are converted into a video signal and an audio signal by the decoding unit 102. The video signal and the audio signal are output to the video audio output device 110.

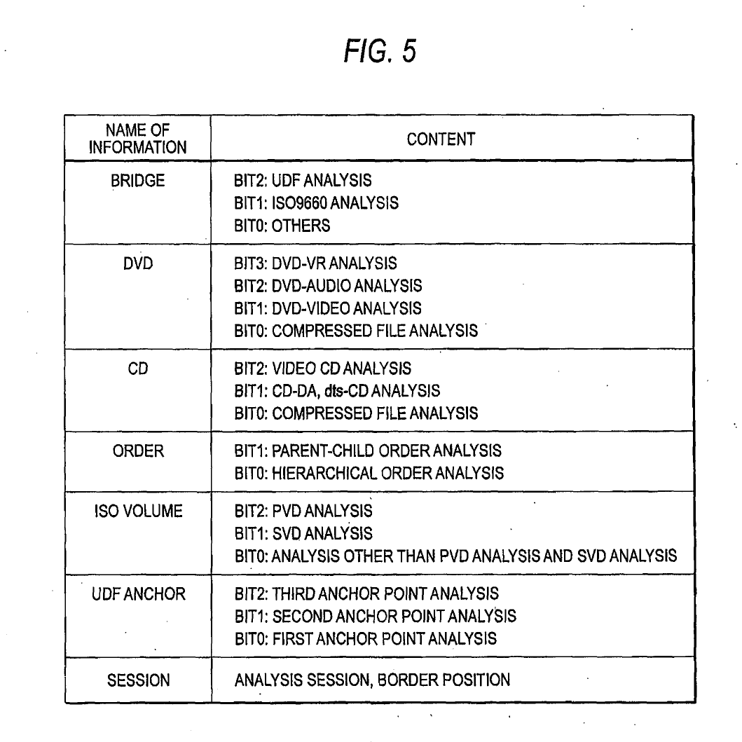

When an unrecoverable fault has occurred during the course of analysis of a file (step S206), the CPU notifies occurrence of a fault (step S203), imposes limitations on the file analysis request from the input device 109, and further saves the fault information shown in FIG. 5 to be described later in the fault information storage unit 104.

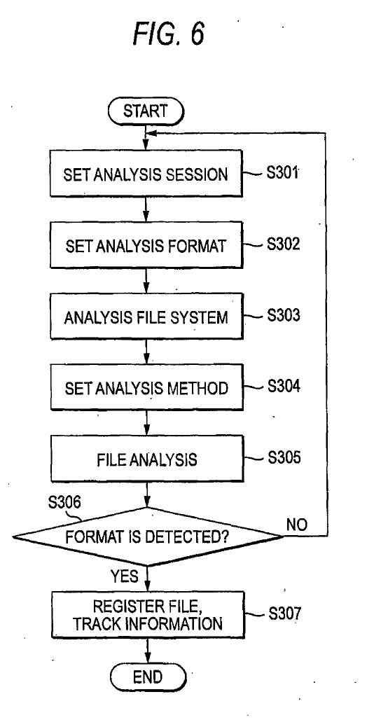

The CPU sets analysis setting items of steps S301 to S304 in FIG. 6 to be described later according to the fault information shown in FIG. 5, and performs file analysis operation according to a flowchart shown in FIG. 6 (step S305). The CPU can thereby again perform file analysis operation without imposing limitations on the file analysis request from the input device 109. File analysis processing shown in FIG. 6 corresponds to alternative processing referred to herein.

Step S306 shown in FIG. 6 is a step for determining whether or not a format of the recording medium 101 can be detected from a result of file analysis performed in step S305. In step S306, when the format of the recording medium 101 is detected, file and track information of the recording medium 101 are registered (step S307). In step S306, when the format of the recording medium 101 is not detected, processing returns to step S301, where the respective analysis setting items of steps S301 to S304 are again set.

A method for setting the respective analysis setting items shown in FIG. 6 is described by reference to example fault information of the present embodiment of the present invention shown in FIG. 5.

A term “Bridge” shown in FIG. 5 is information showing which one of UDF and ISO9660 is subjected to occurrence of a fault during performance of file system analysis. In the case of a recording medium (e.g., UDF-ISO Bridge) that is readable by means of both the file system UDF and the file system ISO9660, if information showing which one of file system analysis operations is subjected to a fault is recorded, there will be a conceivable possibility that the file system analysis can be performed by UDF even when the file system analysis cannot be performed by ISO9660.

For instance, in a case that fault has occurred in the course of file system analysis compliant with ISO9660, the fault information storage unit 104 sets “1” to Bridge bit 1. A fact that the fault has occurred in the course of file system analysis compliant with ISO9660, is saved. When the CPU again performs file analysis, the control processing branch unit 105 sets an analysis file system so as to perform file system analysis compliant with UDF in step S303 shown in FIG. 6. As a result, repeat of the fault can be prevented.

A DVD and a CD shown in FIG. 5 are information showing a type of a medium subjected to a fault during course of format analysis. For instance, conceivable formats recorded in DVD mediums include DVD-VR standards, DVD-Audio standards, DVD-Video standards, compressed music formats, like MP3 and WMA, and video formats other than the foregoing standards, and so on. Conceivable formats recorded in CD mediums include Video CD standards, CD-DA standards, dts-CD standards, compressed music formats, like MP3 and WMA, and video formats other than the foregoing standards, and so on.

In the case of a DVD medium, the reproducing apparatus 100 performs format analysis operation in sequence of; for instance, DVD-Video→DVD-Audio→DVD-VR→a compressed format. For instance, when fault occurred in the course of file format analysis of DVD-Video, the fault information storage unit 104 sets “1” in DVD bit1, thereby saving the fact that fault occurred in the course of DVD-Video analysis. When format analysis is again performed, the control processing branch unit 105 sets the analysis format to DVD-Audio in step 302 shown in FIG. 6. The setting makes it possible to analyze DVD-audio without performing DVD-Video analysis subjected to a fault last time. The sequence of analysis can also be changed even in the case of a CD medium along like procedures.

A term “Order” in FIG. 5 is information showing an analysis method under which fault occurred during the course of analysis of the file system ISO9660. The fault information storage unit 104 saves the nature of the analysis method under which fault occurred, and the control processing branch unit 105 sets, in step S304 shown in FIG. 6, an analysis method which has not been subjected to a fault. The file analysis method recorded in connection with ISO9660 includes a parent-child order search and a hierarchical order search. A folder analysis order in which a parent folder and a child folder are analyzed in this sequence is called a parent-child order search. On the contrary, analyzing all folders in a single hierarchical layer and then folders in a subsequent hierarchical layer are called a hierarchical order search.

Terms “ISO Volume” and “UDF Anchor” shown in FIG. 5 are information showing which one of targets is subjected to a fault during performance of analysis. The file system ISO9660 includes a PVD (Primary Volume Descriptor) and an SVD (Supplementary Volume Descriptor). File analysis can be performed, so long as either of the descriptors is read. An AVDP (Anchor Volume Descriptor Pointer) is recorded in a maximum three locations in the file system UDF. If any one of the recorded AVDPs can be read, the CPU can perform file analysis. The fault information storage unit 104 saves information about which one of ISO volume analysis and UDF Anchor analysis was subjected to a fault. In step S304 shown in FIG. 6, the control processing branch unit 105 sets an analysis method not yet subjected to a fault.

A term “Session” shown in FIG. 5 is information showing which one of sessions in a multi-session disc is subjected to a fault or which one of borders on a multi-border disc is subjected to a fault. The fault information storage unit 104 saves a session and a border where fault occurred during analysis. The control processing branch unit 105 sets, in step S301 shown in FIG. 6, a session or a border where fault did not occur.

When file analysis processing cannot again be performed according to the fault information shown in FIG. 5, the fault information is notified in step S203 shown in FIG. 4, and the input device 109 limits a file analysis request.

Respective functional units of the decoding unit 102 and the control unit 103 of the present embodiment of the present invention are implemented by an LSI 111 that is typically an integrated circuit. Each of the functional units can also be discretely embodied as one chip or embodied into such one chip that some or all of the functional units are included in the chip. Further, each of the functional units can also be embodied as one chip so as to include the ROM 107 and the extended RAM 108.

The functional units are implemented in the form of an LSI in the present embodiment. However, the device is often called an IC, a system LSI, a super LSI, or an ultra LSI according to a degree of integration.

If another integrated circuit technique replaceable with the LSI makes its appearance as a result of advancement of the semiconductor technique or by virtue of other derivative techniques, the functional units can also be integrated naturally by use of the technique.

It goes without saying that the present invention is not limited to the embodiment mentioned thus far and susceptible to various alterations. The alterations shall also fall in a scope of the present invention.

The reproducing apparatus of the present invention yields an advantage of the ability to prevent occurrence of a similar uncontrollable state by branching control processing through use of stored fault information even the apparatus became unrecoverable from an uncontrollable state during control processing, and hence is useful as a reproducing apparatus.

The disclosure of Japanese patent application No. 2008-149419 filed on Jun. 6, 2008 in Japan, including specification, drawings and claims is incorporated herein by reference in its entirety.

What is claimed is:

1. A reproducing apparatus that reproduces content recorded in a recording medium, comprising:
a first execution unit configured to perform control processing for reproducing the content recorded in the recording medium;
a second execution unit configured to execute a processing routine that is invoked when the reproducing apparatus has become unrecoverable or temporarily uncontrollable during the control processing;
a storage unit configured to store fault information showing that the reproducing apparatus is in an unrecoverable state or temporarily uncontrollable; and
a branch unit configured to cause alternative processing, which is for preventing the reproducing apparatus from again entering an unrecoverable state or temporarily becoming uncontrollable after the reproducing apparatus has once become unrecoverable or temporarily uncontrollable during the control processing, to branch off from the control processing which is for reproducing the content recorded in the recording medium, by using the fault information stored in the storage unit and that executes the branched alternative processing.

2. The reproducing apparatus according to claim 1, wherein the processing routine includes processing for rebooting the reproducing apparatus by resetting software after the fault information has been saved in the storage unit.

3. The reproducing apparatus according to claim 1, wherein the fault information is one that makes it possible to specify a state in which the reproducing apparatus has become unrecoverable or temporarily uncontrollable and that includes a state of the reproducing apparatus and information about the recording medium.

4. The reproducing apparatus according to claim 3, wherein the branch unit causes the control processing to branch according to the state of the reproducing apparatus and the information about the recording medium.

5. The reproducing apparatus according to claim 1, wherein the fault information shows a misalignment error.

6. The reproducing apparatus according to claim 1, wherein the fault information shows an unauthorized memory access error.

7. The reproducing apparatus according to claim 1, wherein the fault information shows a timeout error of a watchdog timer.

8. An integrated circuit comprising:
a first execution unit configured to perform control processing of a reproducing apparatus that reproduces content recorded in a recording medium;
a second execution unit configured to execute a processing routine which is invoked when the reproducing apparatus has become unrecoverable or temporarily uncontrollable during the control processing;
a storage unit configured to store fault information showing that the reproducing apparatus is in an unrecoverable state or temporarily uncontrollable; and
a branch unit configured to cause alternative processing, which is for preventing the reproducing apparatus from again entering an unrecoverable state or temporarily becoming uncontrollable after the reproducing apparatus has once become unrecoverable or temporarily uncontrollable during the control processing, to branch off from the control processing, by using the fault information stored in the storage unit and that executes the branched alternative processing.

9. The integrated circuit according to claim 8, wherein the processing routine includes processing for rebooting the reproducing apparatus by resetting software after the fault information has been saved in the storage unit.

10. The integrated circuit according to claim 8, wherein the fault information is one that makes it possible to specify a state in which the reproducing apparatus has become unrecoverable or temporarily uncontrollable and that includes a state of the reproducing apparatus and information about the recording medium.

11. The integrated circuit according to claim 10, wherein the branch unit causes the control processing to branch according to the state of the reproducing apparatus and the information about the recording medium.

12. The integrated circuit according to claim 8, wherein the fault information shows a misalignment error.

13. The integrated circuit according to claim 8, wherein the fault information shows an unauthorized memory access error.

14. The integrated circuit according to claim 8, wherein the fault information shows a timeout error of a watchdog timer.

15. A method for reproducing content recorded in a recording medium, comprising:
a first execution step of performing control processing of a reproducing apparatus that reproduces the content recorded in the recording medium;
a second execution step of executing a processing routine which is invoked when the reproducing apparatus has become unrecoverable or temporarily uncontrollable during the control processing;
a step of storing fault information showing that the reproducing apparatus is in an unrecoverable state or temporarily uncontrollable; and
a step of causing alternative processing, which is for preventing the reproducing apparatus from again entering an unrecoverable state or temporarily becoming uncontrollable after the reproducing apparatus has once become unrecoverable or temporarily uncontrollable during the control processing, to branch off from the control processing, which is for reproducing the content recorded in the recording medium, by using the fault information and executing the branched alternative processing.

16. The reproducing method according to claim 15, wherein the processing routine includes processing for rebooting the reproducing apparatus by resetting software after the fault information has been saved in a storage unit.

17. The reproducing method according to claim 15, wherein the fault information is one that makes it possible to specify a state in which the reproducing apparatus has become unrecoverable or temporarily uncontrollable and that includes a state of the reproducing apparatus and information about the recording medium.

18. The reproducing method according to claim 17, wherein the branch unit causes the control processing to branch according to the state of the reproducing apparatus and the information about the recording medium.

19. The reproducing method according to claim 15, wherein the fault information shows a misalignment error.

20. The reproducing method according to claim 15, wherein the fault information shows an unauthorized memory access error.

21. The reproducing method according to claim 15, wherein the fault information shows a timeout error of a watchdog timer.
